(19) United States
(12) Patent Application Publication
(10) Pub. No.: US 2023/0160316 A1
(43) Pub. Date: May 25, 2023

(54) ABRASIVE MATERIAL, A METHOD FOR MANUFACTURING AN ABRASIVE MATERIAL AND A SUBSTRATE COATED WITH AN ABRASIVE MATERIAL

(71) Applicants: Rolls-Royce Deutschland Ltd & Co KG, Blankenfelde-Mahlow (DE); Rolls-Royce plc, London (GB)

(72) Inventors: Susanne SCHRÜFER, Zossen (DE); Matthew HANCOCK, Derby (GB); Kevin LONG, Derby (GB)

(21) Appl. No.: 17/917,489

(22) PCT Filed: Mar. 15, 2021
(86) PCT No.: PCT/EP2021/056552

§ 371 Date: Oct. 6, 2022

(30) Foreign Application Priority Data
Apr. 24, 2020 (DE) 10 2020 205 248.4

(51) Int. Cl. F01D 11/12; F01D 5/28

(52) U.S. Cl. CPC F01D 11/122; F01D 5/288; F05D 2240/307; F05D 2300/611

(57) ABSTRACT

The invention relates to an abrasive material including a nickel aluminide intermetallic phase, in particular a beta nickel aluminide (β-NiAl) intermetallic phase with a Laves phase, as a matrix for abrasive particles. It also relates to a method manufacturing an abrasive material and a blade in a turbomachinery with an abrasive material.

The present disclosure relates to an abrasive material with the features of claim 1, a method for manufacturing an abrasive material with the features of claim 11, and a substrate coated with an abrasive material with the features of claim 14.

Turbine sealing systems in aircraft engines comprise an abradable material which is generally applied to a static component (e.g. a seal segment) and an abrasive material which is applied to a rotating component (e.g. a turbine blade or a compressor blade). The abrasive material cuts into the abradable material in a defined way and is used e.g. for turbine blade tip clearance control (i.e. minimizing the blade tip clearance) and which is important for the efficiency of the turbine.

Known abrasive materials (U.S. Pat. No. 6,355,086 B2 and U.S. Pat. No. 8,266,801 B2) use either cubic boron nitride particles held within a CoNiCrAlY metal matrix or within a superalloy matrix to cut into abradable material. U.S. Pat. No. 8,266,801 B2 mentions a directed laser deposition process to deposit polycrystalline nickel superalloys.

Abradable material is e.g. known from U.S. Pat. No. 7,479,328 B2 as a coating system used on segments or e.g. from U.S. Pat. No. 8,124,252 B2 using a rare earth silicate as a porous abradable coating for ceramic matrix composite seal segments.

Further improvements in the uniformity of abrasive coverage across the tip of a blade applied using a directed laser deposition process were disclosed in US 2017/129053 A.

At higher temperatures, known abrasive materials tend to smear across the abradable material and the blade during operation rather than cut into the abradable material. As operating temperatures in aircraft engines are increased for higher efficiencies, abrasive materials particularly for those higher temperatures are required.

According to a first aspect, there is provided an abrasive material comprising a nickel aluminide intermetallic phase, in particular a beta nickel aluminide (β-NiAl) intermetallic phase with a Laves phase. In particular, with a Laves phase with a hexagonal phase structure. In one embodiment, the Laves phase comprises Ta, in particular in the form of τ₁NiAlTa. The intermetallic phase with the Laves phase form a matrix for abrasive particles which are part of the abrasive material.

In a further embodiment, the overall content of Ta in the abrasive material is between 1 at. % and 20 at. %, in particular between 1, 5 to 3 at. % or 6 and 9 at. %

Another embodiment has a quaternary addition to the NiAlTa alloy such as Cr, Mo, Nb, and/or V. In particular, the NiAlTa and Beta-NiAl phases can comprise up to 7.5 at. % Cr.

In another embodiment, the abrasive particles comprise cubic boron nitride, silicon nitride, silicon carbide, zirconia and/or alumina-based oxides. The abrasive particles can be coated, in particular with Ti and/or Ni.

It is also possible that the abrasive particles are vertically distributed in the matrix, in particular in the form of layers. This will ensure that abrasive particles will available if the top layer has been removed during operation. The abrasive particles can also be stacked in a direction essentially perpendicular to the surface.

The issues are also addressed by a method for manufacturing an abrasive material with the features of one of the claims 1 to 10.

In one embodiment of the method the substrate is heated or pre-heated for the deposition of the matrix and/or the abrasive particles. This prevents cracks in the materials. The heating can e.g. be effected by induction or high temperature lamps.

The issues are in particular addressed by a substrate, in particular a blade in turbomachine with a tip coated with an abrasive material of at least one of claims 1 to 10.

It will be understood that the invention is not limited to the embodiments above-described and various modifications and improvements can be made without departing from the concepts described herein. Except, where mutually exclusive, any of the features may be employed separately or in combination with any other features and the disclosure extends to and includes all combinations and sub-combinations of one or more features described herein.

Some embodiments are described in an exemplary way in the following figures.

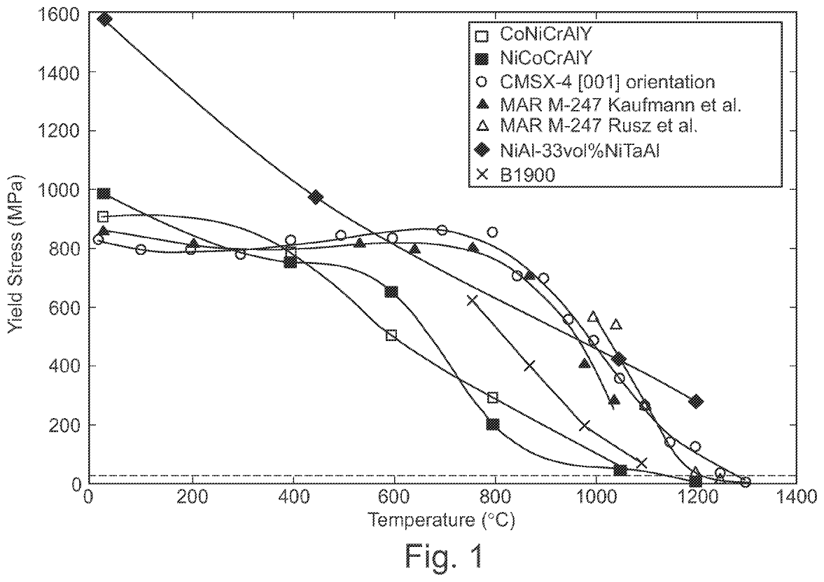

FIG. 1 shows a graph indicating the yield strength in dependence of the temperature;

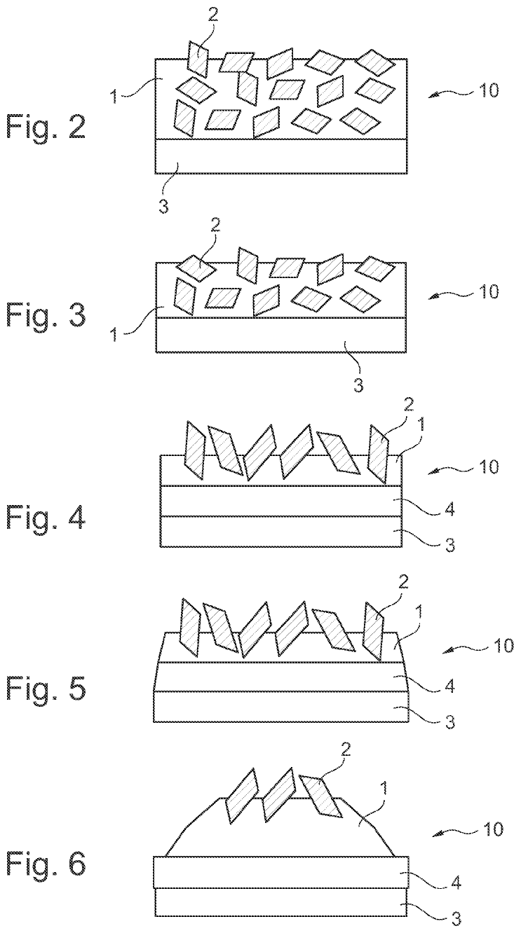

FIG. 2 schematically shows a cross-sectional view of an embodiment of an abrasive material on top of a substrate before a mechanical rub;

FIG. 3 schematically shows the cross-sectional view of the embodiment of FIG. 2 after a mechanical rub;

FIG. 4 schematically shows a cross-sectional view of an embodiment in which the metal matrix is deposited first and subsequently the abrasive particles;

FIG. 5 schematically shows a cross-sectional view of an embodiment;

FIG. 6 schematically shows a cross-sectional view of an embodiment with tapered sides;

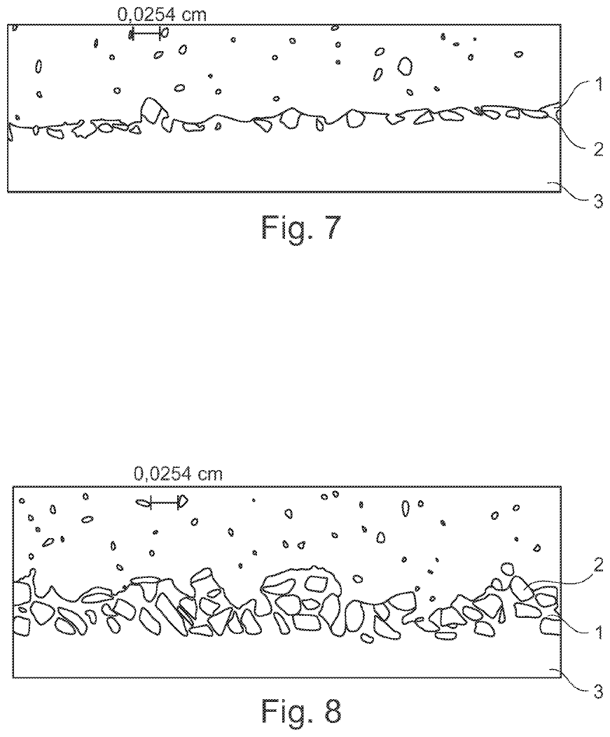

FIG. 7 shows a cross-sectional view of substrate with a an abrasive material with low stacking of abrasive particles;

FIG. 8 shows a cross-sectional view of substrate with a an abrasive material with stacking of abrasive particles.

In the following, the use of embodiments of abrasive materials 10 with a NiAl intermetallic phase, in particular a beta nickel aluminide (β-NiAl) intermetallic phase with a Laves phase addition, is described. The NiAl phase with the Laves phase is used as a matrix 1 for abrasive particles 2, as will be shown in connection with FIGS. 2 to 6.

With the new abrasive material 10 under high temperatures, e.g. above 1100° C., an abrasive cutting into known Mg spinel and CMC abradable material is possible.

An Mg spinel abradable system is a high thermal conductivity abradable coating system which does not use a dislocator phase in the abradable portion of the coating system. This makes it more difficult to cut with an abrasive tip of a blade using known abrasive materials at operating with elevated temperatures. Hence, the abradable system requires a higher strength abrasive material at elevated operating temperatures.

This is possible with embodiments of an abrasive material 10 with a NiAl intermetallic phase, in particular a beta nickel aluminide (β-NiAl) intermetallic phase with a Laves phase addition. Other NiAl intermetallic phase are e.g. NiAl₃ or Ni₃Al.

The continuity of the Laves phase that forms is dependent on the Tantalum content of the alloy. Below 3 at. % Tantalum the Laves phase precipitates out discontinuously on NiAl grain boundaries. Above 3 at. % Tantalum, the NiTaAl completely covers the grain boundaries and forms a continuous skeleton required to produce a continuous Laves phase. Material with additions above 20 at. % Tantalum was found to have inferior oxidation performance.

It was found that heat treatment at 1100° C. caused some of the Laves phase to transform to a L2 Ni₂AlTa Heusler phase, this phase having slightly inferior mechanical properties compared with the Laves phase.

This work has been confirmed in [B. Zeumer et al, Intermetallics 5, 7, 1997, Pages 563-577] who studied Ta contents up to 10 at. %. β-NiAl dissolves up to 0.2 at. % Ta in solid solution with any additional Ta forming Laves phases, β-NiAl with up to 3 at. % Ta forms precipitates of Laves phase primarily on grain boundaries, as the Ta content increases the Laves phase covers the grain boundaries completely to form a continuous network. The observed strengthening of β-NiAl by Ta is a result of both solid-solution hardening and precipitation hardening.

But the testing of this material showed that the material described herein retains its strength to significantly higher temperatures than prior art materials. This higher strength is used to anchor the abrasive particles 2, such as cubic boron nitride particles in place at a higher operating temperature than the prior art materials.

FIG. 1 shows the benefit of a NiAl-33 vol % NiAlTa alloy (diamond symbol) having a yield strength of over 250 MPa at 1200° C. while prior art materials are significantly lower than that. In particular close to the 35 MPa threshold. Analysis has determined that 35 MPa is the minimum yield strength required to anchor the abrasive material.

Quaternary additions of elements to the NiAlTa phase could be made to optimise individual properties. Examples of quaternary elemental additions are Chromium, Molybdenum, Niobium and/or Vanadium.

Quaternary additions of Chromium to the NiAlTa system improved ductility relative to the NiAlTa system but had reduced high temperature creep strength. This addition is considered to have potential for the application in blades of a gas turbine engine.

It is further recognised that low-level additions such as nitrogen, oxygen, sulphur and/or phosphorus can have a significant negative effect on mechanical and oxidation performance of the abrasive material 10 and the amount these additions in the matrix needs to be controlled.

In the following, two embodiments for manufacturing an abrasive material 10 are described.

As an example, a matrix 1 using a NiAlTa Laves phase along with cubic boron nitride as abrasive particles 2 are used. The application of the materials can be effected by a blown powder directed Laser Deposition process, a composite electroplating, diffusion bonding or a thermal spray method.

There are two potential application deposition sequences which will be described below.

The baseline sequence is that the metal matrix 1 and abrasive particles 2 will be co-deposited using a technique such as directed laser deposition, thermal spray or diffusion bonding. This means the matrix 1 and the abrasive particles 2 are deposited in the same process step. This allows a mixed structure where cubic boron nitride abrasive particles 2 are stacked upon each other (i.e. there is a vertical distribution of the abrasive particles 2 in the matrix 1) as shown in FIG. 2. In the embodiment shown, approximately three abrasive particles 2 are stacked upon each other. FIGS. 3 and 4 show that by tailoring the manufacturing process conditions, the amount of abrasive particle stacking can be controlled.

The cross-sectional view of a substrate according to FIG. 7 was produced using parameters show very little stacking of the abrasive particles 2, FIG. 8 was produced with parameters which promote the stacking of abrasive particles 2. As can be seen, some material removed from the top would expose abrasive particles 2 vertically below.

FIGS. 7 and 8 also show the shape of the abrasive particles 2 in a cross-section. The particles are on average not rounded and comprise flat surfaces forming edges where the meet. This gives the abrasive particles an angular shape.

This stacking of abrasive particles has the advantage of sustained cutting performance by which the cubic boron nitride particles at the top of the stack are removed due to a heavy rub/incursion of the blade into the abradable material (not shown here). As shown in FIG. 3, there are multiple abrasive particles 2 below which will be exposed for additional ability to cut into the high temperature abradable capacity.

The abrasive particles can, but do not have to be deposited in discrete layers to enable this behaviour.

An alternative sequence of manufacture would be to deposit the metal matrix 1 first followed by deposition/embedding of the abrasive particles 2 which is shown in FIG. 4. The matrix 1 and the abrasive particles 2 may be applied by directed laser deposition, electroplate or thermal spray. Before the deposition of the abrasive material 10 a bond coat/bond layer 4 may be applied onto the substrate 3. The bond coat layer 4 is a layer of metallic material deposited directly on to the substrate 3, this is typically the same composition as the matrix material 1 mentioned earlier although other compositions may also have satisfactory properties in particular oxidation resistance, tensile strength and co-efficient of thermal expansion.

This sequence may yield improvements in the oxidation resistance of the metal matrix 1 by leaving a continuous layer of nickel aluminium tantalum below the abrasive particles 2. The particles 2 such as cubic boron nitride can introduce short-circuit diffusion paths for oxygen below the particles compromising oxidation life of the abrasive.

This sequence might also yield an improvement in cutting performance, as it leaves the abrasive particles 2 anchored in the outer region and protruding out of the metal matrix 2.

In one of the embodiments, cubic boron nitride is used for the abrasive particles 2 but other ceramics, such as silicon nitride and alumina can also be used. It is also possible to use mixtures of different ceramic types.

The average size of the abrasive particles 2 can be in the range of 125 to 600 microns in particular between 125 and 250 microns.

This method may include in one embodiment the use of heating or pre-heating of the substrate 3 to reduce propensity for cracking of the nickel aluminium tantalum material during deposition, this heating may be applied preferably by induction or alternatively high temperature halogen lamp heating.

The form of the deposition of the Laves phase comprising the NiAlTa can be optimized to maximise coverage at a similar height across the tip of the turbine blade (see FIG. 5). A sub-optimal case is shown in FIG. 6 which has tapered sides resulting with less abrasive particles 2 towards the tip of the abrasive material 10.

It is likely that the abrasive material 10 will be deposited in a metastable microstructural condition where post-deposition heat treatments and service temperatures and times result in microstructural equilibrium to the nickel aluminide plus Laves phase microstructure. As mentioned earlier, heat treatment at 1100° C. caused some of the Laves phases to transform to L2 Ni2AlTa Heusler phase.

Current abrasive deposits are applied after blade machining (Grind, EDM and hole drilling) but before other coatings (aerofoil bond coat, aerofoil TBC, shank protection) and final heat treatments are applied to the blade. This new abrasive material 10 is anticipated to be applied at this same stage of manufacture although it may be applied at a later or earlier stage in the manufacture sequence. This typically depends on blade functionality and manufacturing yield issues.

The effect of post-deposition heat treatments/thermal processing due to further coating is to be determined and optimised in future trials.

The materials proposed are compatible with current single crystal superalloy, coatings and other treatments applied to state-of-the-art turbine blades. This is similar to prior art materials.

### LIST OF REFERENCE NUMBERS

1 matrix for abrasive particles
2 abrasive particles
3 substrate
4 bond layer/coat
10 abrasive material

1. Abrasive material comprising a nickel aluminide intermetallic phase, in particular a beta nickel aluminide (β-NiAl) intermetallic phase with a Laves phase, as a matrix for abrasive particles.

2. Abrasive material according to claim 1, wherein the Laves phase has a C14 hexagonal phase structure.

3. Abrasive material according to claim 1, wherein the Laves phase comprises Ta, in particular in the form of τ₁NiAlTa.

4. Abrasive material according to claim 3, wherein the overall content of Ta in the material is between 1 at. % and 20 at. %, in particular between 1, 5 to 3 at. % or 6 and 9 at. %.

5. Abrasive material according to claim 3, wherein a quaternary addition to the NiAlTa alloy is Cr, Mo, Nb, and/or V.

6. Abrasive material according to claim 5, wherein the NiAlTa+Beta-NiAl phases comprises up to 7.5 at. % Cr.

7. Abrasive material according to claim 1, wherein the abrasive particles comprise cubic boron nitride, silicon nitride, silicon carbide, zirconia and/or alumina-based oxides.

8. Abrasive material according to claim 1, wherein the abrasive particle is coated, in particular with Ti and/or Ni.

9. Abrasive material according to claim 1, wherein the abrasive particles are vertically distributed in the matrix, in particular in the form of layers.

10. Abrasive Material according to claim 1, wherein the abrasive particles are stacked in a direction essentially perpendicular to the surface.

11. Method for manufacturing an abrasive material according to claim 1, wherein the matrix and the abrasive particles are deposited on a substrate in the same process step or wherein the matrix is deposited in a first process step, the abrasive particles are deposited in a subsequent second process step.

12. Method according to claim 11, wherein the substrate is heated or pre-heated for the deposition of the matrix and/or the abrasive particles.

13. Method according to claim 11, wherein the heating is effected by induction or high temperature lamps.

14. Substrate, in particular a blade in a turbomachine with a tip coated with an abrasive material of at least claim 1.
